(19) United States
(12) Patent Application Publication
(10) Pub. No.: US 2007/0288470 A1
(43) Pub. Date: Dec. 13, 2007

(54) Selection of media for public rendering via user devices

(76) Inventors: Hannu Kauniskangas, Oulu (FI); Kari Kaarela, Oulu (FI); Kirmo Koistinen, Oulu (FI); Timo Tervo, Oulu (FI)

Correspondence Address: Hollingsworth & Funk, LLC, Suite 125, 8009 34th Avenue South, Minneapolis, MN, 55425, US

(21) Appl. No.: 11/449,410

(22) Filed: Jun. 8, 2006

(51) Int. Cl. G06F 17/30

(52) U.S. Cl. 707/10

(57) ABSTRACT

Selecting media for public rendering via user devices involves coupling one or more proximately co-located mobile devices to a network. Metadata of the mobile devices is discovered via the network. The metadata is indicative of media preferences of users associated with the mobile devices. The metadata is correlated to determine media selections in accordance with the media preferences of the users, and the media selections are publicly rendered for the users

### FIELD OF THE INVENTION

This invention relates in general to computing devices, and more particularly to selection of media via locally coupled personal processing devices.

### BACKGROUND OF THE INVENTION

Universal Plug and Play™ (UPnP) defines an architecture for pervasive, peer-to-peer networking between all types of consumer electronics, including intelligent appliances, wireless devices, and PCs of all form factors. UPnP technologies provide a way for disparate processing devices to exchange data via proximity or ad hoc networks. The UPnP framework is designed to bring easy-to-use, flexible, standards-based connectivity to ad-hoc or unmanaged networks whether in the home, in a small business, public spaces, or attached to the Internet. UPnP technologies provide a distributed, open networking architecture that leverages TCP/IP and the Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices. The UPnP specification includes standards for service discovery. Various contributors publish UPnP device and service descriptions, thus creating a way to easily connect devices and simplifying the implementation of networks. It is the goal of UPnP to enable home electronics to seamlessly interact, thus furthering the usefulness of such devices.

The UPnP standard includes standards for service discovery, and is mainly targeted for proximity or ad hoc networks. Various contributors publish UPnP device and service descriptions, thus creating a way to easily connect devices and simplifying the implementation of networks. UPnP is designed to work in many environments, including the home, businesses, public spaces, and on devices attached to the Internet. The UPnP standard is an open architecture that leverages Web technologies and is designed to provide ad-hoc networking and distributed computing.

UPnP and related protocols were developed primarily to allow consumers to easily assemble a home network, and to access and control devices not normally associated with networked computing. However, the flexible nature of UPnP means that it can be implemented anywhere, and can be adapted to uses not foreseen by the originators of the network framework. For example, UPnP can be used on mobile devices that normally connect to wireless provider networks. Such devices may contain secondary wired or wireless interfaces that allow the devices to communicate with other entities of home or business networks.

By their nature, mobile devices are easily transported, thus users tend to store important information in the devices. Information traditionally stored on such devices includes address, phone numbers, personal calendars, etc., that are in many cases related to managing communications of the end user. However, as the data processing capabilities and multimedia features of such devices increase, mobile devices may also be used for storing and managing media, such as music and video. Although there are business applications for such media, typical users store videos, pictures, and music for their own enjoyment. As such, this stored media presents a unique view of the tastes and preferences of the individual user. Such indicators of tastes and preferences are valuable in the social context, such as in meeting people with similar tastes. Therefore, leveraging the user preference data store in mobile devices via enabling technologies such as UPnP in social situations is desirable.

### SUMMARY OF THE INVENTION

To overcome limitations in the prior art described above, and to overcome other limitations that will become apparent upon reading and understanding the present specification, the present invention discloses a system, apparatus and method for selection of media via locally coupled personal processing devices. In one embodiment, a method involves coupling one or more proximately co-located mobile devices to a network. Metadata of the mobile devices is discovered via the network. The metadata is indicative of media preferences of users associated with the mobile devices. The metadata is correlated to determine media selections in accordance with the media preferences of the users, and the media selections are publicly rendered for the users.

In more particular embodiments, publicly rendering the media involves publicly rendering the media on at least one of the mobile devices and/or on a jukebox that is proximately co-located with the users. Publicly rendering the media may involve accessing the media from one of the mobile devices. The devices may be queried to discover the metadata, and discovering the metadata of the mobile devices involves using an ad-hoc, peer-to-peer network protocol, such as Universal Plug and Play. Coupling the one or more proximately co-located mobile devices to the network may also involve coupling the devices into an ad-hoc, peer-to-peer network.

In other, more particular embodiments, discovering the metadata of the mobile devices involves querying the mobile devices to determine the metadata, and the metadata is discovered in response to the queries. In another arrangement, discovering the metadata of the mobile devices may involve publicly announcing the metadata from the mobile device at periodic intervals. The metadata may include at least one of a genre, user rating, access count, and access times associated with instances of the media. The metadata may be formed at the mobile devices based on actions of the users associated with the mobile devices.

In another embodiment of the invention, an apparatus includes a network interface capable of communicating via a local network when the apparatus is proximate to a location where rendered media may be perceived by a user of the apparatus. A processor is coupled to the network interface; and a memory coupled to the processor. The memory includes metadata indicative of media preferences of the user of the apparatus. The memory also includes instructions that cause the processor to communicate the metadata to an entity of the local network for purposes of correlating the metadata to determine media selections in accordance with preferences of the user. The media selections are rendered to the user in response to submission of the metadata to the entity.

In more particular embodiments, the apparatus includes media rendering hardware, and the instructions further cause the processor to render the selections via the media rendering hardware in response to the submission of the metadata to the entity. Rendering the selections via the media rendering hardware may involve accessing the media selections via the local network. The memory may further include at least one of the media selections. In such an arrangement, publicly rendering the media involves providing the at least one media selection to a rendering device via the local network.

In other, more particular embodiments, the instructions cause the processor to communicate the metadata to an entity of the local network using an ad-hoc, peer-to-peer network protocol, such as Universal Plug and Play. The instructions may also further cause the processor to receive a query to determine the metadata via the network, and the instructions may cause the processor to communicate the metadata to the entity of the local network in response to the query. The instructions may also further cause the processor to publicly announce the metadata via the network interface at periodic intervals. The metadata may include at least one of a genre, user rating, access count, and access times associated with instances of media accessed by the user via the apparatus. In one configuration, the entity of the local network includes the apparatus, and the instructions further cause the processor to receive other metadata from other devices of the local network for purposes of correlating the other metadata with the metadata of the apparatus to determine media selections in accordance with a plurality of users, and facilitate publicly rendering the media selections for the plurality of users.

In another embodiment of the invention, an apparatus includes a network interface capable of communicating with one or more mobile devices via a network when the mobile devices are proximate to a location where rendered media may be perceived by users of the mobile devices. A processor is coupled to the network interface and a memory is coupled to the processor. The memory includes instructions that cause the processor to retrieve metadata from the mobile devices. The metadata is indicative of media preferences of users associated with the mobile devices. The instructions cause the processor to correlate the metadata to determine media selections in accordance with the media preferences, and facilitate public rendering of the media selections for the users.

In more particular embodiments, the apparatus includes rendering hardware, and wherein the instructions further cause the processor to facilitate publicly rendering the media selections by rendering the media selections via the media rendering hardware. In such an arrangement, rendering the selections via the media rendering hardware involves accessing at least one of the media selections from one of the mobile devices via the local network. The memory may further include at least one of the media selections, and facilitating publicly rendering the media involves providing the at least one media selection to a rendering device via the local network.

In other, more particular embodiments, the instructions cause the processor to retrieve the metadata from the mobile devices using an ad-hoc, peer-to-peer network protocol, such as Universal Plug and Play. The instructions may also further cause the processor to submit a query to the mobile devices to determine the metadata via the network, and the instructions cause the processor retrieve the metadata from the mobile devices in response to the quer

In another embodiment of the invention, a computer-readable medium has instructions stored thereon that are executable by a mobile device capable of being coupled to a network. The instructions are executable for performing steps of facilitating storage on the device of metadata indicative of media preferences of the user of the apparatus, detecting when the mobile device is proximate to a location where rendered media may be perceived by a user of the mobile device, and submitting the metadata to an entity of the local network for purposes of correlating the metadata to determine media selections in accordance with preferences of the user, wherein the media selections are rendered to the user in response to submission of the metadata to the entity.

In another embodiment of the invention, a computer-readable medium having instructions stored thereon that are executable by a server device capable of being coupled to a local network. The instructions are executable for performing steps including detecting when one or more mobile devices that are coupled to the network are proximate to a location where rendered media may be perceived by users of the mobile devices and retrieving from the mobile devices metadata indicative of media preferences of users associated with the mobile devices. The steps also include correlating the metadata to determine media selections in accordance with the media preferences, and facilitating publicly rendering the media selections for the users.

In another embodiment of the invention, a system includes: means for coupling one or more proximately co-located mobile devices to a network; means for discovering via the network metadata of the mobile devices that is indicative of media preferences of users associated with the mobile devices; means for correlating the metadata to determine media selections in accordance with the media preferences of the users; and means for publicly rendering the media selections for the users

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIG. 2 is a block diagram illustrating how media preferences can be formatted and communicated according to embodiments of the invention;

FIG. 3 is a block diagram illustrating distributed rendering according to embodiments of the invention;

FIG. 4 is a block diagram of a mobile device according to embodiments of the invention;

FIG. 5 is a block diagram of a network server according to embodiments of the invention;

FIG. 6 is a flowchart illustrating a method for rendering media based on preference data derived from user devices according to embodiments of the invention; and

FIG. 7 is a flowchart illustrating a method for rendering media via a server based on preference data derived from user devices according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to methods, systems, and apparatus that enable one or more people to influence the rendering of media (or other group experience) in a public setting by way of personal electronics. In particular, the setting may be anywhere people might commonly gather to socialize, such as a home, bar, restaurant, nightclub, music hall, recreation center, etc. The media that is played may be music, video, graphics/pictures, text, or any other communicative media known in the art. In a typical example, a system of this sort may include a musical jukebox in a bar or restaurant.

In order to select appropriate media for playback, the electronic devices of users are queried, either with or without input from the users. This typically involves having the devices coupled for some amount of time to a local network or other data transfer means. The devices will at least have data that indicates a preference of the user related to the media being selected. For example, it is common for people to listen to music on portable devices. People may carry digitally encoded music on the devices, and may use the devices to listen to broadcast or streamed music. Such devices have limited capacity, and it takes some effort for users to put music on such devices (e.g., by transferring from online stores or home computers, extracting songs from a CD, etc.). Therefore, it is likely that the music contained on such devices is reflective of the preferences of the user.

Further, the devices may be able to store other metadata related to the preferences that indicates some selections are more important to the user than other selections. This other metadata may be formed via the mobile device based, directly or indirectly, on user actions. For example, the users may make apply explicit ratings (e.g.; star ratings) to certain media selections, and/or select a particular set of preference data for sharing. In another arrangements, the preferences may be derived based on the user's actions related to the stored data, such as frequency of play/access, sending links to media to other users for purposes of sharing, etc.

This preference data can be gathered for a number of users in a social setting. For example, the devices can include a network application that announces the availability of preference data from the device. Another entity of the network can collect this data from a number of users. This data represents a collective set of media preferences applicable to the current group of users, and can be used to select media for rendering to the group. Therefore, without the individual users even having to make a conscious choice, media can be selected and rendered in conformance with the tastes of users in the social setting.

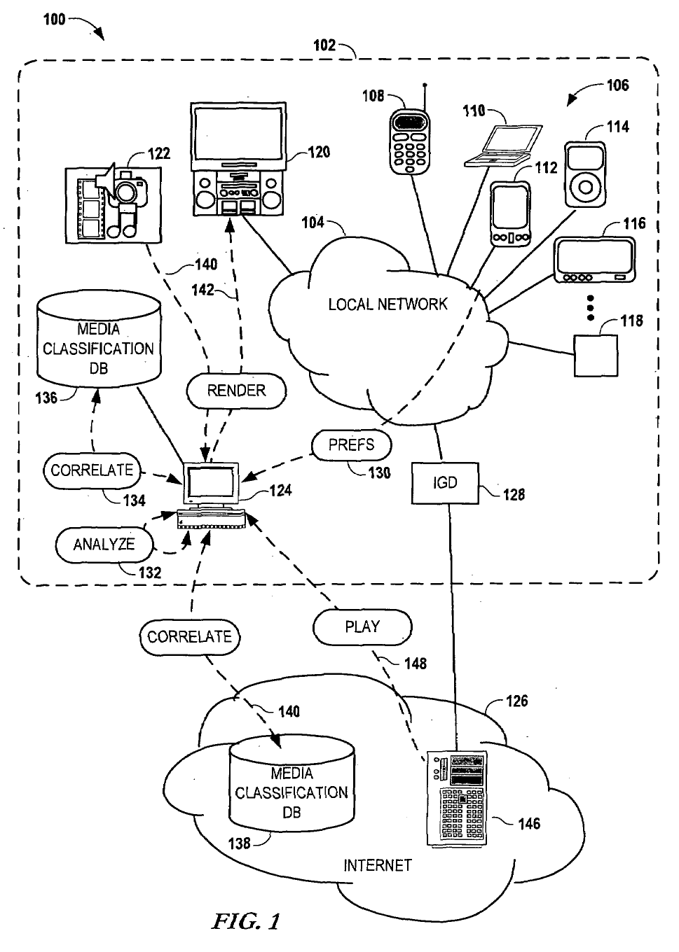

In reference now to FIG. 1, a block diagram 100 illustrates a system according to embodiments of the invention. A physical boundary defines a local space 102. The dimensions of the local space 102 is only limited by the distances needed for people to experience the relevant media, and for the user devices to be queried by some sort of processing arrangement that gathers the data. Thus, the space 102 may be as large as (or larger than) a stadium if the media can be played to enough people (e.g., via a public address system or Jumbotron™ display) and if the networking technology is used can access a relevant number of user devices in the venue. On the other extreme, the space 102 may be as small as a taxi or a phone booth. In smaller spaces 102, the limiting factor in such as system is that there may be few people in the space. Because not every individual will carry the relevant devices/data, there may be times in a smaller space 102 where no data is available.

The public space 102 may include at least one network 104 that is capable of supporting communications with one or more user devices 106. The local network 104 may include any combination of data transmission media and protocols. For example, the network may utilize wired or wireless data transmission media. Similarly, devices 106 on the local network 104 may various physical and data link layer protocols to intercommunicate, including, Ethernet, FDDI, PPP, ATM, HDLC, Fibre Channel, X-10, serial/parallel point-to-point connections, etc. A number of higher layer network protocols may operate on the network 104 as well, including TCP/IP, UDP/IP, IPX, Appletalk, ICMP, ARP, SNMP, DNS, FTP, NetBEUI.

The user devices 106 include some manner of data processing capabilities, and in particular are capable of storing data describing user preferences in regard to certain types of media. The user devices 106 are also capable of engaging in some manner of data transfer, either directly or indirectly, with the network 104. In the illustrated diagram 100, the local network devices 106 include a mobile phone 108, laptop computer 110, personal digital assistant 112, portable music player 114, tablet computer 116, or any other device as represented by generic data processing device 118. Preferably, the network 104 and its underlying protocols are designed to be generic and flexible so that many types of control or data processing functionality can be abstracted and offered as a service to other entities on the network 104.

In one embodiment, the local network 104 may support one or more protocols for ad-hoc, peer-to-peer service discovery and interoperability. An example of ad-hoc, peer-to-peer protocols are those protocols used in the UPnP architecture. UPnP uses the Simple Service Discovery Protocol (SSDP) for service discovery, and is generally built on top of Internet Protocol (IP) based networks. Although concepts of the present invention may be described in terms of UPnP networks, those familiar with the applicable art will appreciate that these concepts may be applied to any manner of ad-hoc, peer-to-peer networking arrangement suitable for consumer or business networks. For example, the Service Location Protocol (SLP) and Jini™ are protocols that provide functions similar to those of UPnP.

Also included in the local network 102 is a media renderer 120 and a media server 122. The media renderer 120 may be any device that turns signals into human perceivable sensations, including sound, video, color, scent, vibration, etc. The media server 122 is generally any device that can store the underlying media signals and selectably send those signals to at least the media renderer 120. The media server 122 may include dedicated hardware (e.g., standalone, network-attached storage) or may be incorporated into other devices such as the computer 124 and/or media renderer 120. For example, the media renderer 120 and server 122 may be combined to form a jukebox device.

Although the function of media renderer 120 and server 122 may provided any one or more electronics devices known in the art, in the UPnP context, the media renderer 120 and server 122 are specific logical entities defined in the UPnP Audio Video (AV) specification. The UPnP AV specification is a specialized area of UPnP intended for the digital distribution of entertainment content throughout a home/office network. UPnP AV deals with three specific logical entities, media server 122, media renderer 120, and control points (e.g., computer 124). The UPnP control points are devices that allow users to select media available from the media server 122 and direct selected media to be rendered on the renderer 120.

The local network 104 is typically designed to service a limited physical region, as indicated by the boundary 102. The protocols used in the local network 104 (e.g., UPnP) often assume that the network 104 will need to support only a limited number of devices operating within a reasonably small area. However, many devices on the local network 104 may benefit from information services available via an external network 126, particularly the Internet. The UPnP specification defines a special service/function known as an Internet Gateway Device (IGD) 128. The IGD 128 can provide routing and firewall services on behalf of the devices 106, 120, 122, 124 of the local UPnP network 104. It will be appreciated that a conventional gateway device may perform equivalent functions on a non-UPnP network 104.

In one embodiment of the invention, the user devices 106 have a specialized component that enables sharing of user media preferences via the network 104. In particular, an entity of the network 104, such as computer 124, gathers this data automatically from the user devices 106. For example, the user devices 106 may offer a service on the network 104 that allows downloading of preference metadata 130 that can be used to derive preferences of the associated users. In another example, the computer 124 could advertise a service requesting that users submit particular preference metadata 103. In this latter case, the users of the devices 106 may be prompted to manually submit such data via devices 106.

The metadata 130 is collected by the computer 124 and analyzed 132. This analysis 132 may involve determining relative weights of individual metadata entries 130. For example, where the metadata 130 describes songs, parts of the metadata (e.g., rankings, frequency of play) may indicate the user's relative level of interest relative to each song. Similarly, if the same or similar songs are gathered from multiple user devices 106, this may be indicative of the tastes of the users as a group. Thus the ranking of an individual, category of media may be influenced by each individual's metadata 130, as well as the relative frequency of media among users of the devices 106 that fit some category.

The computer 124 may use the analysis 132 of media selections in various ways. In one example, the individual selections themselves may be played via the media server 122 and/or renderer 120. In another example, the computer 124 may correlate 134 the media selections to determine a particular genre or classification of selections that are generally descriptive of the metadata analysis 132. Using songs again as an example, the analysis 132 may determine that the users of the devices 106 generally prefer rock music, and perhaps more specifically, heavy metal. This determination of general tastes can be used to choose particular music that conforms to this genre for playback via the media server 122 and renderer 120. The selection of music (or other media) may be correlated 134 using a classification database 136.

One classification database 136 that relates to music is known as the Music Genome Project. The Music Genome Project is an attempt to capture and describe categories of music by analyzing some 400 attributes that describe particular song. The Music Genome Project also enlists Internet users via such services as Pandora to hear and rate songs. This user interaction can further improve the accuracy of classifications, as well as exposing users to new songs that fit the classification of their preferences. It will be appreciated that the concepts underlying the Music Genome Project may be used to classify any media known in the art, and not just music. The computer 124 may access such classification data from a locally accessible database 136, or a remote database 138, as indicated by path 140.

The classification database(s) 136, 138 may both classify the correlated data 134, 140, and provide recommended selections for rendering to the users in the local area 102. Rendering is represented by paths 142, 144. The selections may be obtained and rendered 140, 142 via a locally stored repository (e.g., media server 122) or via a remotely accessible entity such as Internet server 146 as indicated by path 148. For example, the server 146 may be part of a paid, streaming media service that caters to this type of business or activity.

It will be appreciated that the illustrated system 100 holds many advantages over traditional ways of determining user desires related to playback of media. The users of devices 106 need not make any effort to think about what they would like to hear. Further, the “invisible” submission of entries allows the users to maintain anonymity, which is beneficial for those who prefer not to reveal their personal tastes, at least until they first find out that those around them have similar preferences. The system 100 is also highly adaptable. For example, a nightclub might have older patrons early in the evening, and slowly migrate to younger patrons as the night progresses. The changing of age (and tastes) in the audience could be reflected in the selection of media through the night.

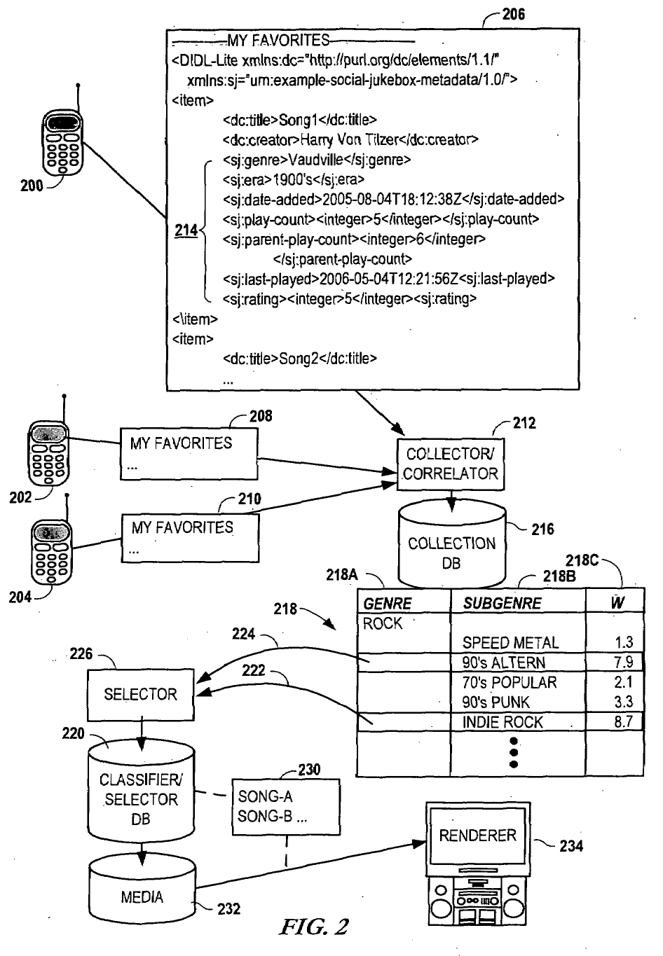

In reference now to FIG. 2, a more detailed example is presented of how media preferences can be formatted and communicated in accordance with embodiments of the invention. Terminal devices 200, 202, 204 include software that is capable of detecting and formatting preference data, here represented by respective favorites data 206, 208, 210. The terminals 200, 202, 204 also include interface software that allows the favorites data to be communicated to a network entity, here represented as collector/correlator component 212.

The collector/correlator 212 and terminals 200, 202, 204 may use any ad-hoc or pre-arranged mechanisms for communicating the favorites data 206, 208, 210. In one example, the terminals 200, 202, 204 may implement a service similar to a UPnP Content Directory Service (CDS). The CDS is a UPnP-defined service that allows media servers and similar devices to expose available content in an XML tree data structure. The content discoverable via CDS may include individual pieces of content such as songs and video clips. The CDS content may also include containers, which represent collections of items such as playlists and photo albums. Each CDS content object, whether an item or container, includes metadata that describes various attributes of the object, such as title, artist, etc. The CDS allows UPnP devices, such as a UPnP control point, to browse the content and obtain detailed information about individual content objects. CDS provides lookup functions such as “browse” and “search” that allows devices to discover individual data objects stored on the device.

In the illustrated example, the terminals 200, 202, 204 include a CDS-like functionality. Similar to CDS, the terminals 200, 202, 204 may provide the favorites data 206, 208, 210 as XML-formatted descriptors of the types of media accessible via the devices 200, 204, 206. However, unlike media servers, this descriptive data 206, 208, 210 need not be media that is accessible via the devices 200, 204, 206, because the devices 200, 202, 204 do not necessarily need to serve the underlying media like a media server. Thus the descriptive data 206, 208, 210 in this example may not need to provide data such as encoding formats, file size, Uniform Resource Identifier (URI) of the media, etc. It may also be desirable to include additional metadata which is not defined in the CDS standard. For example, favorites data 206 includes additional data 214 that describes genre, era, date added, play count, parent play count (e.g., album), last played, and user supplied rating.

The collector/correlator 212 may organize the favorites data 206, 208, 210 into a database 216. One example data structure of the database 216 is shown as table 218. This table tabulates the collected metadata and organizes the metadata by genre and sub-genre (where appropriate). The determination of genre 218A and sub-genre 21 8B may be made based on identifiers in the metadata 206, 208, 210 itself, as well as via an independent source such as classifier database 220. The table 218 also includes weightings 218C for each genre and/or sub-genre based on the metadata 206, 208, 210 and other factors, such as the frequency in all data collected of instances (e.g., songs) belonging to a particular genre/sub-genre.

It will be appreciated that the database 216 may use different or additional tables (not shown) for ranking and correlating media preferences. For examples, tables may apply rankings based on artist name, year of publication, album names, etc. In addition, other data besides individual media descriptors may be considered. For example, the metadata 206, 208, 210 in this example may also include descriptors of broadcast or Internet radio stations, chat rooms, public personal data of the user, buddy lists, and any other data that might be related to media interests of the user. All of these types of data may either be merged into existing database tables (e.g., table 218) formed using media descriptors 206, 208, 210, or used to create specific tables in the database.

Based on the weightings 218C (or other ranking criteria) determined for the current data set 216, the collector/correlator 212 may select one or more classifications of media to render. Here, the collector/correlator 212 has selected two somewhat similar categories from table 218 that are more highly ranked than the others. The collector/correlator 212 creates descriptors of the categories and communicates those descriptors to a selector function 226, as indicated by paths 222, 224. The generalized descriptors 222, 224 might include a genre/sub-genre, example songs, characterization factors (e.g., Music Genome descriptors) or other data useful in selecting particular media selections to render. The selector function 226 may reference a classifier/selector database 220 that chooses particular media selections 230 based on the supplied criteria 222, 224. These selections 230 can be sent from a media server 232 to a renderer 234 by the selector function 226.

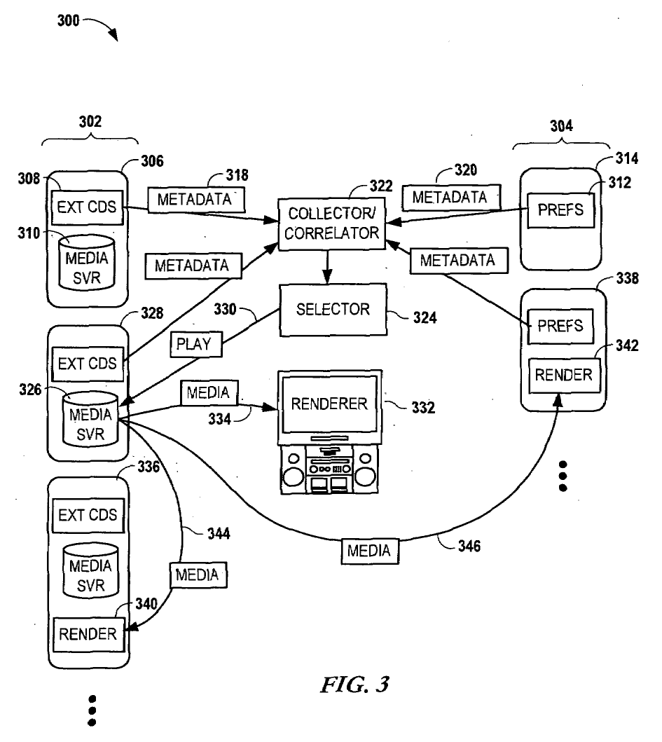

In reference now to FIG. 3, a block diagram 300 illustrates different features that may be included in systems and apparatus in accordance with embodiments of the invention. Generally, the block diagram 300 includes user devices 302, 304 on a local network such as shown in FIG. 1. In this example, the user devices are divided into two categories: those devices 302 that are willing and able to act as media servers, and those devices 304 that are either unable or unwilling to act as media servers. Generally, the server devices 302 will include an extended CDS 308 and media server 310 as seen on device 306. The extended CDS 308 may operate substantially similar to the UPnP AV CDS, except that additional metadata useful for determining user preferences may be included in the directory browse or search results. The extended CDS 308 may also have other additional features, such as a mandatory collection called “Favorites” or the like, where the preference metadata can easily be accessed.

The non-media server devices 304 may at least include a CDS-like preferences interface 312, as seen in device 314. The preferences interface 312 may not need to rely on media stored on the device itself 314. For example, the preferences interface 312 may utilize manually input data, references to accessed hyperlinks, data imported from other devices (e.g., playlist of home computer media player, etc.). The preferences interface 312 may be response substantially similarly to a CDS, except that it may, for example, return null URIs for media locations.

As described in greater detail above, metadata (e.g., metadata 318, 320) can be sent from the devices 302, 304 to a collector/correlator component 322. Based on an analysis by the collector/correlator component 322, a selector component 324 determines an appropriate selection for rendering. In this example, the selector 324 utilizes a media server interface (e.g., media server 326 of device 328) in order to access the chosen media, as indicated by the play signal 330. As in previous examples, the selected media can be rendered by a media renderer 332 that is part of the local infrastructure (e.g., a jukebox), as indicated by path 334. However, in this example terminals 336 and 338 have respective UPnP renderers 340, 342, and the media can also be sent to those renderers 340, 342, as indicated by paths 344, 346. In this way, the system can distribute functions of both media service and rendering between different mobile devices 302, 304.

As may be apparent from the arrangement in FIG. 3, it is entirely possible for the arrangement 300 to operate without any infrastructure components. For example, the devices 302, 304 could establish a self-forming mesh network using wireless interfaces of the devices 302, 304, thus removing the need for any network routers or other infrastructure. The collector/correlator 322 and selector 324 could be implemented in one of the devices 302, 304 as well. As already discussed above, the functions of media server and media renderer can be handled within at least some of the devices. In this way, the devices 302, 304 can create a self-forming media player that renders selections based on the collective tastes of the participants.

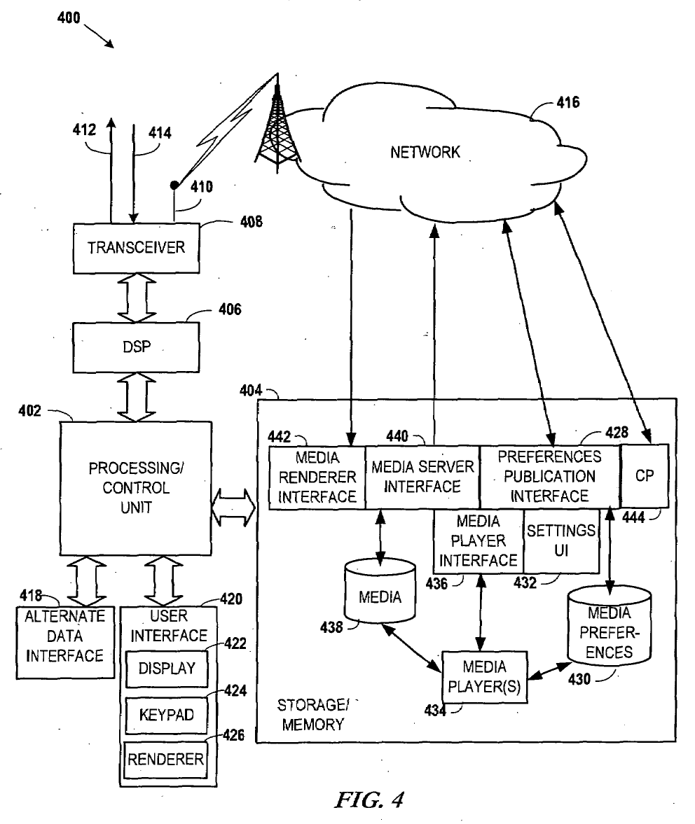

A user device that includes capabilities according to embodiments of the invention is shown as a mobile computing arrangement 400 in FIG. 4. Those skilled in the art will appreciate that the exemplary mobile computing arrangement 400 is merely representative of general functions that may be associated with such mobile devices, and also that landline computing systems similarly include computing circuitry to perform such operations.

The processing unit 402 controls the basic functions of the arrangement 400. Those functions associated may be included as instructions stored in a program storage/memory 404. In one embodiment of the invention, the program modules associated with the storage/memory 404 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 400 via data signals, such as being downloaded electronically via one or more networks, such as the Internet and an intermediate wireless network(s).

The mobile computing arrangement 400 includes hardware and software components coupled to the processing/control unit 402 for performing network data exchanges. The mobile computing arrangement 400 may include multiple network interfaces for maintaining any combination of wired or wireless data connections. In particular, the illustrated mobile computing arrangement 400 includes wireless data transmission circuitry for performing network data exchanges.

This wireless circuitry includes a digital signal processor (DSP) 406 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 408, generally coupled to an antenna 410, transmits the outgoing radio signals 412 and receives the incoming radio signals 414 associated with the wireless device.

The incoming and outgoing radio signals 412, 414 to communicate with a mobile services network 416. The network 416 may include any voice and data communications infrastructure known in the art, including CDMA, W-CDMA, GSM, EDGE, etc. The network 416 may also include short-range networks, using technologies such as 802.11 Wireless Local Area Network (WAN), Ultrawideband (UWB), Bluetooth, etc. The transceiver 408 may be adapted to communicate via these short-range networks 416, or the arrangement 400 may include an alternate data interface 418 for purposes of connecting to such networks. The alternate data interface 418 may include any combination of wired or wireless data communications circuitry coupled to the processor 402 for purposes of communicating with devices on the network 416.

The processor 402 is also coupled to user-interface elements 420 associated with the mobile terminal 400. The user-interface 420 of the mobile terminal 400 may include, for example, a display 422 such as a liquid crystal display. Other user-interface mechanisms may be included in the interface 420, such as keypads 424, speakers, microphones, voice commands, switches, touch pad/screen, graphical user interface using a pointing device, track ball, joystick, etc. These and other user-interface components are coupled to the processor 402 as is known in the art. In particular, the user interface 420 may contain a renderer 426 for rendering media for rendering media appropriate for a distributed media system as described herein.

The program storage/memory 404 typically includes operating systems for carrying out functions and applications associated with functions on the mobile computing arrangement 400. The program storage 404 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 404 of the mobile computing arrangement 400 may also include software modules for performing functions according to embodiments of the present invention.

In particular, the program storage/memory 404 may include an interface 428 for publishing user media preferences to other entities of the network 416. The publication interface 428 may automatically advertise media preference data 430, which can be stored on and/or derived via the user device 400. The publication interface 428 may also be configured to provide such data 430 in response to queries from the network 416, and may restrict responses to certain entities. The user may control the behavior of the publication interface 428 via a settings user interface (UI) 432. The setting UI 432 may control what data is shared, with whom it is shared, whether associated media is shared, whether to gather similar data from other devices, etc.

The media preferences data 430 may be created and stored in specialized data structures on the device 400. In some arrangements, the data 430 may be derived from one or more media players 434 of the device 400. A media player interface 436 can extract data from the media players 434 and transform the extracted data in a common format. This commonly formatted data is made available to the preferences publication interface 428 for sharing over the network 416.

The arrangement 400 may also include stored media 438 accessible by the media players 434. The media 438 may also be made available to the network 416 via a media server interface 440. The media server interface 440 controls the formatting and presentation of media 438 to other entities of the network 416. The arrangement 400 may also be able to render other media that is offered from other media servers on the network 416, such as represented by the media renderer interface 442. The media renderer interface 442 is involved in initiating downloading and streaming activities with other entities of the network 416, and sending such media to renderer devices 426 and/or the media storage 438.

It will be appreciated that the particular protocols implemented in the various interfaces 428, 440, 442 may be driven by the need for common communication with disparate other devices on the network 416. Therefore, the interfaces 428, 440, 442 may utilize a commonly adopted framework designed for such communications, such as UPnP. For example, the preferences publication interface 428 could be implemented similarly to a UPnP AV CDS. The media server and renderer interfaces 440, 442 could be implemented as the UPnP logical components of the same name. In such a case, the arrangement 400 may include a UPnP control point module 444 for conducting media transactions, such as controlling the local rendering of remotely accessed data.

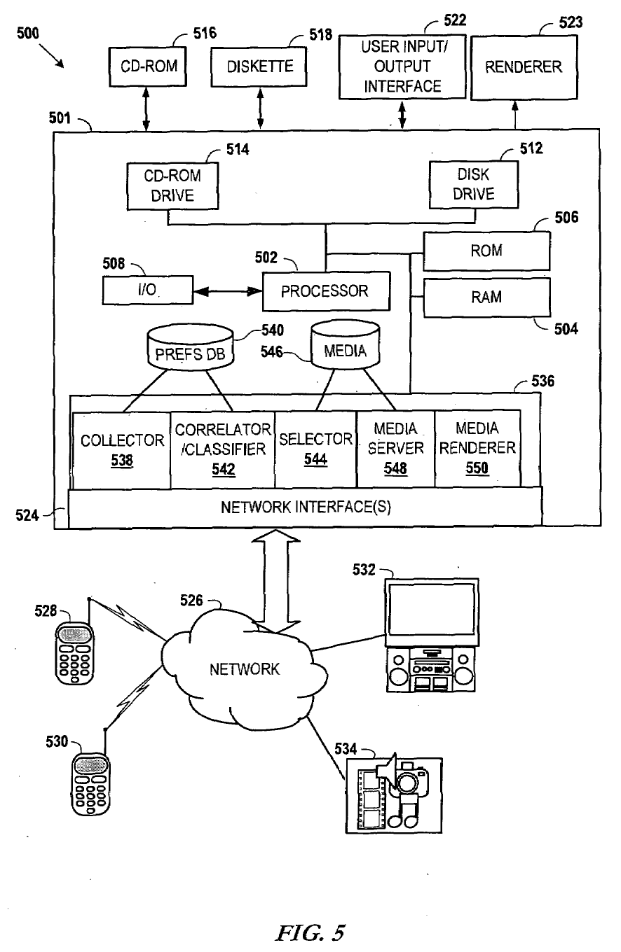

In the preceding figures, various examples were presented a local environment where user devices share preferences for public rendering of media according to embodiments of the invention. In some arrangements, one or more fixed servers may assist in gathering preferences, selecting media based on the preferences, and rendering the selected media. Many types of apparatus may be able to act as such a server, including conventional desktop a portable computers, set top boxes, digital media centers, portable communications devices, and other processing devices known in the art. In reference now to FIG. 5, a block diagram illustrates an example server 500 according to embodiments of the invention. The server 500 includes a computing arrangement 501. The computing arrangement 501 may include custom or general-purpose electronic components. The computing arrangement 501 includes a central processor (CPU) 502 that may be coupled to random access memory (RAM) 504 and/or read-only memory (ROM) 506. The ROM 506 may include various types of storage media, such as programmable ROM (PROM), erasable PROM (EPROM), etc. The processor 502 may communicate with other internal and external components through input/output (I/O) circuitry 508. The processor 502 carries out a variety of functions as is known in the art, as dictated by software and/or firmware instructions.

The computing arrangement 501 may include one or more data storage devices, including hard and floppy disk drives 512, CD-ROM drives 514, and other hardware capable of reading and/or storing information such as DVD, etc. In one embodiment, software for carrying out the operations in accordance with the present invention may be stored and distributed on a CD-ROM 516, diskette 518 or other form of media capable of portably storing information. These storage media may be inserted into, and read by, devices such as the CD-ROM drive 514, the disk drive 512, etc. The software may also be transmitted to computing arrangement 501 via data signals, such as being downloaded electronically via a network, such as the Internet. The computing arrangement 501 may be coupled to a user input/output interface 522 for user interaction. The user input/output interface 522 may include apparatus such as a mouse, keyboard, microphone, touch pad, touch screen, voice-recognition system, monitor, LED display, LCD display, etc. The computing arrangement 501 may also be coupled to a media renderer 523, which may be integrated with or separate from the input/output interface 522. The media renderer 523 generally includes circuitry and transducers that convert electrical signals into signals that are perceivable by humans.

The computing arrangement 501 may be coupled to other computing devices via networks. In particular, the computing arrangement includes a network interface 524 capable of interacting with a local network 526. The network interface 524 may include a combination of hardware and software components, including media access circuitry, drivers, programs, and protocol modules. Ultimately, the computing arrangement 501 may be enabled via the network interface 524 to exchange media preference data between devices 528, 530 of the network 526, and to exchange media and associated metadata with devices such as media renderer 532 and media server 534.

The computing arrangement 501 includes processor executable instructions 536 for carrying out tasks of the computing arrangement 501. These instructions 540 may include a collector 538 that collects media data from user devices 528, 530 via the network 526 (or other data communication medium). The collected data may be placed in a database 540. A correlator/classifier 542 generally reduces and classifies the collected data 540 into formats suitable for a selector component 544 to choose media 546 to render. The media 546 may be stored locally, or on some other element, such as the media server 534 coupled to the local network 526. The selected media 546 may be rendered locally, such as via rendering hardware 523. The media 546 may also be sent to other devices via a media server interface 548. For example the media renderer 532 may stream or download media from the media server interface 548 of the computing arrangement 501. In configurations where the computing arrangement 501 retrieves media for local rendering or other purposes, such as forwarding to other network elements, a media renderer interface 550 receives the media from those serving elements.

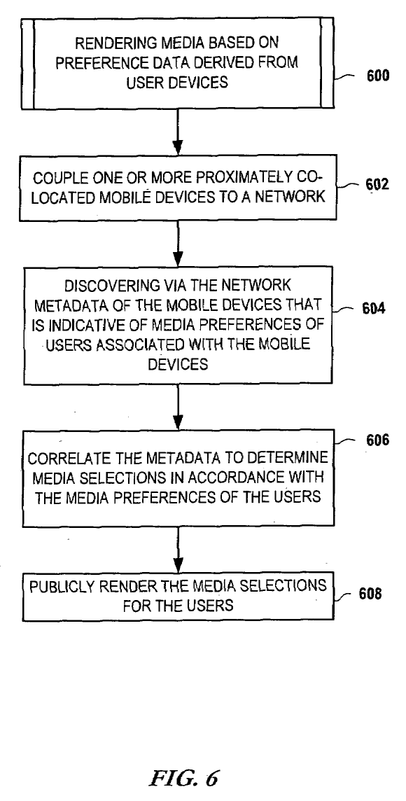

In reference now to FIG. 6, a flowchart illustrates a procedure 600 for rendering media based on preference data derived from user devices. One or more proximately co-located mobile devices are proximately coupled 602 to a network. Metadata of the devices is discovered 604 via the network. The metadata is indicative of media preferences of users associated with the mobile devices. The metadata is correlated 606 to determine media selections in accordance with the media preferences of the users, and the media selections are rendered 608 for the users.

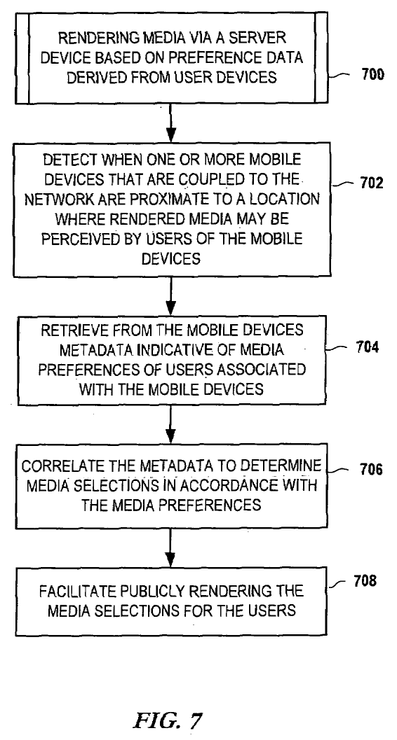

In reference now to FIG. 7, a flowchart illustrates a procedure 700 for rendering media via a server based on preference data derived from user devices. The server detects 702 when one or more mobile devices that are coupled to the network are proximate to a location where rendered media may be perceived by users of the mobile devices. This detection 702 may be presumed in cases where short-range connection technologies are used. For example, where the mobile devices are connected by a short-range technology such as Bluetooth, the ability of the device to connect would suggest it is range so that the device user could perceive any rendered media. In other arrangements, the devices may communicate location data (e.g., geological coordinates) that indicate whether the device's owners would be able to perceive any rendered media relative to the location of the rendering device.

After the mobile devices are detected 702 in the location, metadata may be retrieved 704 from the devices. This metadata is indicative of media preferences of users associated with the mobile devices. The metadata is then correlated 706 to determine media selections in accordance with the media preferences, and the server can then facilitate 708 publicly rendering the media selections for the users.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
coupling one or more proximately co-located mobile devices to a network;
discovering, via the network, metadata of the mobile devices that is indicative of media preferences of users associated with the mobile devices;
correlating the metadata to determine media selections in accordance with the media preferences of the users; and
publicly rendering the media selections for the users.

2. The method of claim 1, wherein publicly rendering the media comprises publicly rendering the media on at least one of the mobile devices.

3. The method of claim 1, wherein publicly rendering the media comprises publicly rendering the media on a jukebox that is proximately co-located with the users.

4. The method of claim 1, wherein publicly rendering the media comprises accessing the media from one of the mobile devices.

5. The method of claim 1, further comprising querying the mobile devices to determine the metadata, and wherein the metadata is discovered in response to the querying.

6. The method of claim 1, wherein discovering the metadata via the network comprises discovering the metadata using an ad-hoc, peer-to-peer network protocol.

7. The method of claim 6, wherein discovering the metadata using an ad-hoc, peer-to-peer network protocol comprises querying the mobile devices using Universal Plug and Play.

8. The method of claim 1, wherein coupling the one or more proximately co-located mobile devices to the network comprises coupling the devices into an ad-hoc, peer-to-peer network.

9. The method of claim 1, wherein discovering the metadata of the mobile devices comprises querying the mobile devices to determine the metadata.

10. The method of claim 1, wherein discovering the metadata of the mobile devices comprises publicly announcing the metadata from the mobile device at periodic intervals.

11. The method of claim 1, wherein the metadata includes at least one of a genre, user rating, access count, and access times associated with instances of the media.

12. The method of claim 1, further comprising forming the metadata at the mobile devices based on actions of the users associated with the mobile devices.

13. An apparatus, comprising:
a network interface capable of communicating via a local network when the apparatus is proximate to a location where rendered media may be perceived by a user of the apparatus;
a processor coupled to the network interface; and
a memory coupled to the processor, the memory including, metadata indicative of media preferences of the user of the apparatus; and
instructions that cause the processor to communicate the metadata to an entity of the local network for purposes of correlating the metadata to determine media selections in accordance with preferences of the user, wherein the media selections are rendered to the user in response to submission of the metadata to the entity.

14. The apparatus of claim 13, further comprising media rendering hardware, and wherein the instructions further cause the processor to render the selections via the media rendering hardware in response to the submission of the metadata to the entity.

15. The apparatus of claim 14, wherein rendering the selections via the media rendering hardware comprises accessing the media selections via the local network.

16. The apparatus of claim 13, wherein the memory further comprises at least one of the media selections, and wherein the instructions further cause the processor to publicly render the media by providing the at least one media selection to a rendering device via the local network.

17. The apparatus of claim 13, wherein the instructions cause the processor to communicate the metadata to an entity of the local network using an ad-hoc, peer-to-peer network protocol.

18. The apparatus of claim 13, wherein the instructions further cause the processor to receive a query to determine the metadata via the network, and wherein the instructions cause the processor to communicate the metadata to the entity of the local network in response to the query.

19. The apparatus of claim 13, wherein the instructions further cause the processor to publicly announce the metadata via the network interface at periodic intervals.

20. The apparatus of claim 13, wherein the metadata includes at least one of a genre, user rating, access count, and access times associated with instances of media accessed by the user via the apparatus.

21. The apparatus of claim 13, wherein the instructions further cause the processor to form the metadata based on user actions.

22. The apparatus of claim 13, wherein the entity of the local network comprises the apparatus, and wherein the instructions further cause the processor to, receive other metadata from other devices of the local network for purposes of correlating the other metadata with the metadata of the apparatus to determine media selections in accordance with a plurality of users; and facilitate publicly rendering the media selections for the plurality of users.

23. An apparatus, comprising:
a network interface capable of communicating with one or more mobile devices via a network when the mobile devices are proximate to a location where rendered media may be perceived by users of the mobile devices;
a processor coupled to the network interface; and
a memory coupled to the processor, the memory including instructions that cause the processor to,
retrieve from the mobile devices metadata indicative of media preferences of users associated with the mobile devices;
correlate the metadata to determine media selections in accordance with the media preferences; and
facilitate publicly rendering the media selections for the users.

24. The apparatus of claim 23, further comprising media rendering hardware, and wherein the instructions further cause the processor to facilitate publicly rendering the media selections by rendering the media selections via the media rendering hardware.

25. The apparatus of claim 24, wherein rendering the selections via the media rendering hardware comprises accessing at least one of the media selections from one of the mobile devices via the local network.

26. The apparatus of claim 23, wherein the memory further comprises at least one of the media selections, and wherein facilitating publicly rendering the media comprises providing the at least one media selection to a rendering device via the local network.

27. The apparatus of claim 23, wherein the instructions cause the processor to retrieve the metadata from the mobile devices using an ad-hoc, peer-to-peer network protocol.

28. The apparatus of claim 23, wherein the instructions further cause the processor to submit a query to the mobile devices to determine the metadata via the network, and wherein the instructions cause the processor retrieve the metadata from the mobile devices in response to the query.

29. The apparatus of claim 23, wherein the metadata comprises at least one of a genre, user rating, access count, and access times associated with instances of media accessed by the users of the mobile devices.

30. A computer-readable medium having instructions stored thereon which are executable by a mobile device capable of being coupled to a network for performing steps comprising:
facilitating storage on the device of metadata indicative of media preferences of the user of the apparatus;
detecting when the mobile device is proximate to a location where rendered media may be perceived by a user of the mobile device; and
submitting the metadata to an entity of the local network for purposes of correlating the metadata to determine media selections in accordance with preferences of the user, wherein the media selections are rendered to the user in response to submission of the metadata to the entity.

31. A computer-readable medium having instructions stored thereon which are executable by a server device capable of being coupled to a local network for performing steps comprising:
detecting when one or more mobile devices that are coupled to the network are proximate to a location where rendered media may be perceived by users of the mobile devices;
retrieving from the mobile devices metadata indicative of media preferences of users associated with the mobile devices;
correlating the metadata to determine media selections in accordance with the media preferences; and
facilitating publicly rendering the media selections for the users.

32. A system comprising:
means for coupling one or more proximately co-located mobile devices to a network;
means for discovering via the network metadata of the mobile devices that is indicative of media preferences of users associated with the mobile devices;
means for correlating the metadata to determine media selections in accordance with the media preferences of the users; and
means for publicly rendering the media selections for the users.
